(19) United States
(12) Patent Application Publication
(10) Pub. No.: US 2007/0168979 A1
(43) Pub. Date: Jul. 19, 2007

(54) Transparent debugging of programs in dynamic translation systems

(75) Inventors: Naveen Kumar, Hillsboro, OR (US); Ramesh Peri, Austin, TX (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Intel Corporation

(21) Appl. No.: 11/322,950

(22) Filed: Dec. 30, 2005

(51) Int. Cl. G06F 9/44

(52) U.S. Cl. 717/124

(57) ABSTRACT

In one aspect, a communication may be received from a debugger. The communication may specify an argument that pertains to an un-translated code. Information may also be received from a dynamic translation system. The information received from the dynamic translation system may be used to relate the argument pertaining to the un-translated code to an argument pertaining to a translated code. Then a call corresponding to the received communication may be provided to an operating system. The call may specify the argument pertaining to the translated code.

### BACKGROUND

1. Field

Embodiments of the invention relate to the field of debugging programs. In particular, one or more embodiments of the invention relate to the field of debugging programs with dynamic translation and/or dynamic instrumentation.

2. Background Information

Debugging is a well-known technique of using a specialized computer program known as a debugger to identify errors, also known as bugs, in the application program. Debuggers generally offer a variety of functions to allow the computer program to be debugged, such as, for example, ability to stop execution of an application program, examine values of program variables, proceed line-by-line through program execution, modify program values or variables, and/or watch for particular conditions.

Debugging has been used with a well-known technique known as dynamic translation. Dynamic translation has been used in a variety of different applications, such as, for example, program analysis, bug isolation, software security, and simulations.

A representative dynamic translation system may receive binary code of an application as input. The dynamic translation system may translate the received binary code to a target code or binary executable, and dynamically store the target code at another location, such as, for example, a code cache, from which the translated code may be executed. A variety of changes to the code may potentially occur during dynamic translation. For example, instructions may be deleted, instructions may be reordered, more instances of instructions may be introduced in the translated code than in the untranslated code, new instructions may be added into the translated code that did not exist in the untranslated code, to name just a few examples.

There are several potential reasons why debugging may be performed with dynamic translation. One such potential reason is that dynamic translation may result in code transformations that expose bugs that are not readily detected in the absence of the code transformation. By way of example, this may be the case when the dynamic translation is used for dynamic optimization. Another such potential reason is that in some debugging systems the dynamic translator is tightly integrated with the host machine such that all applications are translated before execution and such that debugging without dynamic translation may not be convenient or even allowed. By way of example, some security systems that enforce security policies by checking an application's binary code may have such attributes.

Debugging has also been used with a well-known technique known as dynamic instrumentation. Dynamic instrumentation generally refers to an approach in which instrumented code may be dynamically added to and removed from an application program during dynamic translation. By way of example, the instrumented code may be used for such purposes as monitoring, profiling, or otherwise gathering information about the executed program.

Dynamically translated and/or dynamically instrumented programs may impose code location and/or data location challenges on the debugger and the debugging process. Such code location and/or data location challenges may represent the difficulty of identifying the location of the code and/or data of the executing target code that corresponds to the location of the code and/or data of the source code.

The debugger is generally expected to respond to user queries and other commands from the viewpoint of the source code. In the case of statically generated code, the debuggers may produce debug mappings at compile time that may be sufficient to relate source code and source data to the executed target code and data. However, when the target code is generated dynamically with dynamic translation and/or when instrumented code is dynamically added to or removed from the executed target code, the static mappings available to the debugger may be insufficient to properly relate corresponding source and target code and data.

### BRIEF DESCRIPTION OF THE SEVERAL VIEWS OF THE DRAWINGS

The invention may best be understood by referring to the following description and accompanying drawings that are used to illustrate embodiments of the invention. In the drawings:

FIG. 1 is a block diagram of a software architecture showing a dynamic translation and/or dynamic instrumentation system (DT/IS) process that is suitable for implementing one or more embodiments of the invention.

FIG. 2 is a block diagram of a debug architecture, according to one or more embodiments of the invention.

FIG. 3 is a flow diagram of a method of signal handling, according to one or more embodiments of the invention.

FIG. 4 is a flow diagram of a method of reading register values, according to one or more embodiments of the invention.

FIG. 5 is a flow diagram of a method of writing values to a register, according to one or more embodiments of the invention.

FIG. 6 is a flow diagram of a method of writing values to a programs address space, for example main memory, according to one or more embodiments of the invention.

FIG. 7 lists formal notation representing methods similar to those described above in FIGS. 3-6, and which are also suitable for one or more embodiments of the invention.

FIG. 8 shows a block diagram of a computer system upon which one or more embodiments of the invention may be implemented.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure the understanding of this description.

Exemplary Suitable Dynamic Translation and/or Instrumentation System Process

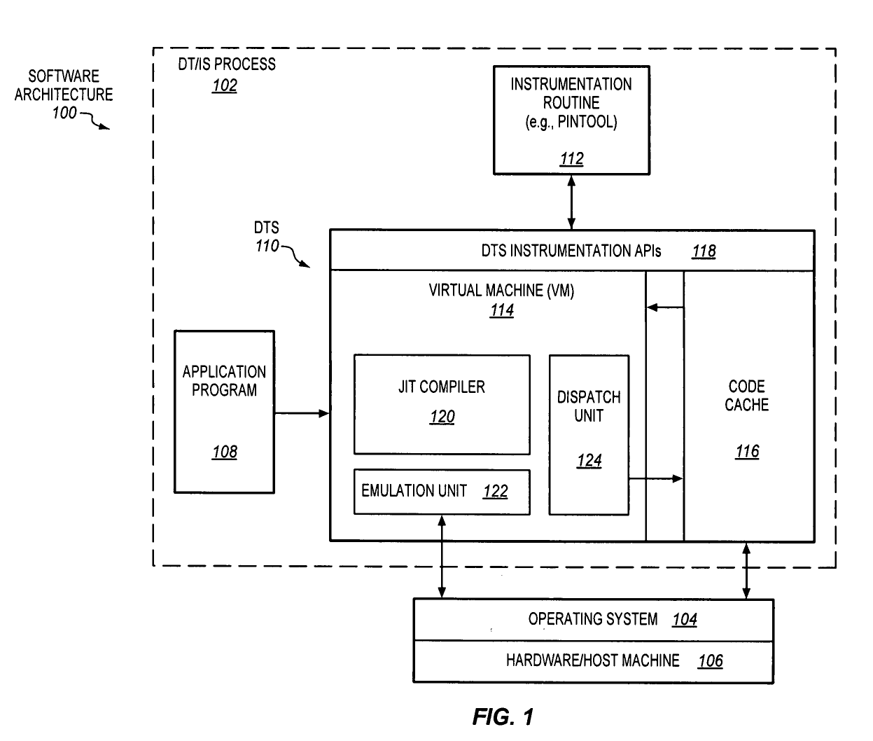

FIG. 1 is a block diagram of a software architecture 100 showing a dynamic translation and/or dynamic instrumentation system (DT/IS) process 102 that is suitable for implementing one or more embodiments of the invention. The software architecture includes the aforementioned DT/IS process 102, an operating system 104, and hardware and/or a host machine 106. Suitable platforms include, but are not limited to, an x86/Linux platform, a Sparc/Solaris platform, and other platforms known in the arts.

The DT/IS process includes an application program 108, a dynamic translation system (DTS) 110, and an instrumentation routine 112. The application program, pin, and Pintool may share the same address space.

The DTS and the instrumentation routine may translate and instrument the application program. The DTS includes a virtual machine (VM) 114, a code cache 116, and a DTS instrumentation API (application programming interface) 118 that may be invoked by the instrumentation routine. The instrumentation routine may include instrumentation and analysis routines. In one aspect, the instrumentation routine may be linked with a library to allow it to communicate with the DTS.

After the DTS has gained control of the application program, the VM may coordinate execution of the application. The VM includes a just-in-time (JIT) compiler 120, an emulation unit 122, and a dispatch unit 124. A representative method of performing dynamic translation and instrumentation may include fetching or otherwise receiving code from an application program, compiling the code for example with the JIT compiler, adding instrumentation to the compiled code, providing the code to a code cache with the dispatch unit, and then executing the cached code on the hardware and/or host machine. The emulation unit may be used to interpret instructions that are not executed directly. The emulation unit may also be used for system calls that are handled specially by the VM. The compiled code may be stored in the code cache. The compiled code in the code cache may be executed on the hardware and/or host machine.

The particular DTS illustrated resembles Pin and/or Pin 2, which are available from Intel Corporation, of Santa Clara, Calif. Pintool is an instrumentation routine also available from Intel Corporation that may be used along with Pin and/or Pin 2. However, the scope of the invention is not limited to using either Pin or Pin 2. Other DTS systems known in the arts may optionally be used. Representative examples of other suitable DTS include, but are not limited to, Dyninst, Keminst, Dynamo Rio, and FIST.

II. Exemplary Suitable Debug Architecture Having Interceptor and Mapping Unit

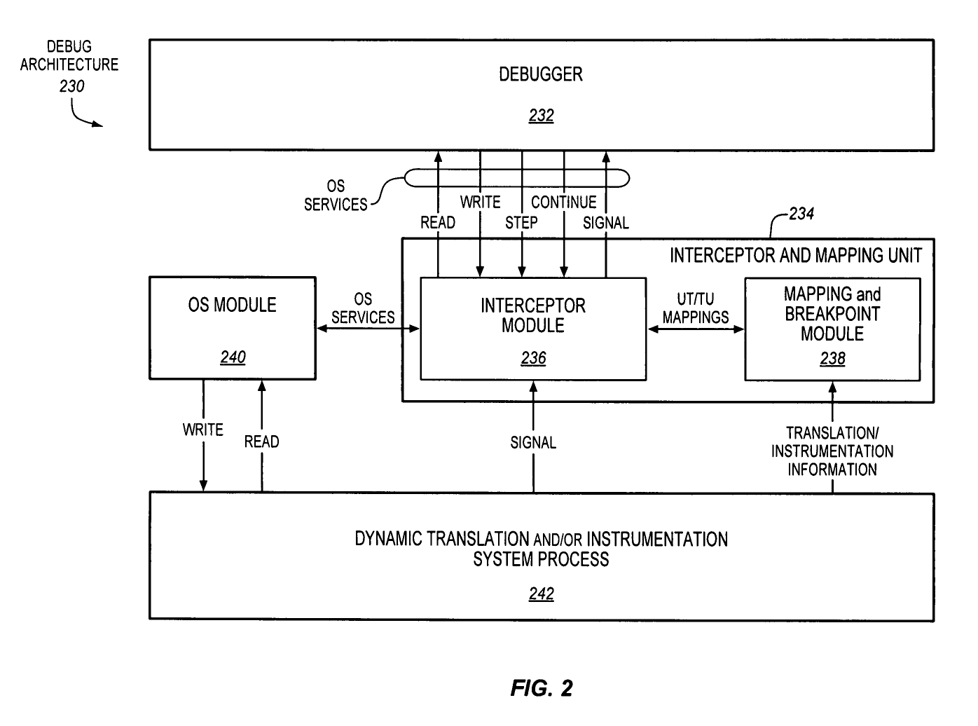

FIG. 2 is a block diagram of a debug architecture 230, according to one or more embodiments of the invention. The debug architecture includes a debugger 232, an interceptor and mapping unit 234, an operating system (OS) module 240, and a dynamic translation and/or instrumentation system (DT/IS) process 242. The interceptor and mapping unit includes an interceptor module 236 and a mapping and breakpoint module 238. The DT/IS process may be similar to that shown in FIG. 1 for Pin or Pin 2 and Pintools or else another DT/IS process known in the arts may optionally be used instead.

These aforementioned components of the debug architecture may communicate or otherwise interact with one another, as shown by the arrowed lines connecting the components. Representatively, the arrows may represent transfer of information from one component to another and/or invocation of one component by another and/or other forms of communication and interaction described herein. Further details of the interactions will be discussed below.

The debugger 232 is in communication with the interceptor module 236 of the interceptor and mapping unit 234. The debugger may represent a specialized computer program that may be used to identify errors, also known as bugs, in the application program. Suitable publicly available debuggers, according to various embodiments of the invention, include, but are not limited to, GNU Project Debugger (GDB), CodeView available from Microsoft Corporation, AntiC, Broadway, DAEDALUS, Java Platform Debugger Architecture, adb, sdb, e2dbg the Embedded ELF Debugger, dbx, Dynamic debugging technique (DDT), Purify, ladebug, SoftICE, Turbo Debugger, TMON, MacsBug, Nolce, Etnus TotalView Allinea Distributed Debugging Tool (DDT), Prism Parallel Debugger, dbg PHP Debugger, doctorj, dprobes, OllyDbg, WinICE, Windbg, and ddb, to name just a few examples.

Accordingly, there are a wide number of commercially available or otherwise available debuggers which users may chose to debug an application program. As will be explained in further detail below, a potential advantage of embodiments of the invention, is that a variety of different conventional debuggers may optionally be used with dynamic translation and/or instrumentation without being modified or substantially modified. The debugger and the user need not be concerned that dynamic translation and/or dynamic instrumentation are being performed. It is thought that such ability to use conventional debuggers for dynamic translation and/or instrumentation without needing to modify the debuggers may help to promote the use of dynamic translation and/or instrumentation in the debugging process and thereby significantly advance the art of debugging programs.

Debuggers may offer various functions to allow the application program to be debugged. Representative functions include, but are not limited to, ability to stop or break execution of an application program at a particular specified point, examine values of program variables, proceed line-by-line through program execution with program variables potentially examined after execution of each line, modify program values or variables while the application program is running, and/or watch for particular conditions. These are just a few illustrative examples. Debuggers may alternatively offer more functions, less functions, or different functions entirely. The scope of the invention is not limited to any known set of debugging functions.

Debuggers may utilize OS services or support in order to implement the debug functions such as those described above. There are five exemplary OS services that are commonly utilized by the debugger to access and control debugging of an application program: (1) a service to read from an application programs address space and/or registers; (2) a service to write to the application programs address space and/or registers; (3) a service to request execution of a single instruction of the application program; (4) a service to continue execution of the stopped application program; and (5) a service to get a signal delivered on behalf of the application program. Other debug commands and functions may optionally be implemented in some debuggers by using these basic services as building blocks.

Traditionally, the debugger may communicate directly with the operating system for such OS services. Operating systems may offer their services through a standard mechanism known as a system call. The system call may provide a standard API (application programming interface) to access the underlying hardware and low-level services, such as file systems. By way of example, in the GNU/Linux operating system, the well-known ptrace (process trace) system call may be used by debuggers in order to request OS services, such as, for example, the five exemplary OS services listed above. The ptrace system call may allow a parent process, such as, for example, the debugger, to observe and control the execution of another process, such as, for example, the application program being debugged. The ptrace system call may also allow the parent process to examine and change the core image and registers of the other process.

In contrast, in one or more embodiments of the invention, the interceptor and mapping unit may intercept or otherwise receive the standard ptrace system call or other OS services communications from the debugger, rather than allowing the OS services communications to go directly to the OS module. In particular, the interceptor module of the interceptor and mapping unit may transparently intercept or otherwise receive the standard ptrace system call or other standard OS services communication from the debugger. In one or more embodiments of the invention, an environmental variable may be set so that standard ptrace system calls may be provided to the mapping and breakpoint module as opposed to the operating system directly. For example, in the GNU/Linux operating system, the LD_LIBRARY_PATH environmental variable may be set. Different environmental variables may be set in different operating systems. As shown in the illustrated embodiment, OS services for “read”, “write”, “step”, “continue” and “signal” are shown going directly to the interceptor module of the interceptor and mapping unit instead of directly to the OS module. For clarity, as used herein, the OS service “step” or “step” in the terms “single-stepping”, “single-step operation”, and the like, is not intended to refer to or invoke the provisions of 35 U.S.C. Section 112, Paragraph 6. The interception may be transparent to the debugger in the sense that the debugger may issue a standard or conventional service call or other communication without needing to know of the existence of the interceptor module and without needing to know of the interception of the communication. Transparency may also be present in that the dynamic translation and/or instrumentation may be hidden from the viewpoint of the debugger and the user.

The interceptor module may include code or other logic that describes what OS services communications are to be intercepted by the interceptor module and what corresponding actions are to be taken by the interceptor module in response to the intercepted communications. In one or more embodiments of the invention, the logic may include logic that may be used to override the existing OS utility, such as, for example, the ptrace utility, and get invoked whenever the debugger makes a service call to ptrace, or another such existing OS utility.

The mapping and breakpoint module is in communication with the interceptor module. Upon intercepting an OS services call, the interceptor module may communicate with or invoke the mapping and breakpoint module to have the mapping and breakpoint module perform mappings on arguments of the OS services call. In one or more embodiments of the invention, the interceptor module may pass or otherwise provide an address or location of an instruction or data that was specified in the OS service call to the mapping and breakpoint module so that the mapping and breakpoint module may map or relate the address, location, or other argument to one or more corresponding arguments.

The mapping and breakpoint module is also in communication with the DT/IS process. In one or more embodiments of the invention, the DTS and/or instrumentation routine of the DT/IS process may be modified slightly in order to communicate or otherwise provide translation and/or instrumentation information to the mapping and breakpoint module. The DT/IS system may read instructions from the application program binary and may potentially apply modifications to the code before writing it to the code cache. In one aspect, the DT/IS system may be modified at each of the points, where the binary is read, modified and written back to code cache, so as to send information to the mapping and breakpoint module. The information may specify details about the translation and/or about any added or removed instrumentation code that may allow the mapping and breakpoint module to perform mappings as described herein. In one or more embodiments of the invention, communication of information between the DT/IS system and the mapping and breakpoint module, which may be two different processes, may be done through a standard inter-process communication mechanism. Suitable standard inter-process communication mechanisms include, but are not limited to, sockets, shared memory, pipes, and the like. As one example, the DT/IS system may write the mapping and breakpoint information to a shared memory, and the mapping and breakpoint module may read from the shared memory and write back to the shared memory. The mapping and breakpoint module may receive translation and/or instrumentation information from the DT/IS process. The mapping and breakpoint module may use the received translation and/or instrumentation information to generate mappings or relations.

One type of mapping is a translated-to-untranslated (TU) mapping. The TU mapping may provide a unidirectional mapping from a translated address of an instruction or data of the target code to an untranslated address of an instruction or data of the program. By way of example, the TU mapping may optionally be used to handle instructions generated by the dynamic translation and/or instrumentation system that do not have a corresponding instruction in the original program, such as, for example, in the case of trampoline code. A TU mapping may also optionally be used to roll-ahead execution of code that is to remain hidden from the viewpoint of the user.

Another type of mapping is the untranslated-to-translated (UT) mapping. The UT mapping may provide a mapping from an untranslated address of the source code to a set of one or more translated addresses of the target code. Note that the UT mapping allows for the possibility that the dynamic translation system may sometimes convert one untranslated source instruction to multiple translated target instructions. The UT mapping may be bi-directional. The UT mappings may not be generated for instrumentation code or like additional code generated by the dynamic translation system that cannot be related to untranslated code.

Yet another type of mapping is a unidirectional translated-to-translated (TT) mapping. By way of example, a TU mapping may optionally be used to roll-ahead execution of code that is to remain hidden from the viewpoint of the user. If desired, further description of similar mappings are disclosed in “Tdb: A Source-level Debugger for Dynamically Translated Programs”, by Naveen Kumar, Bruce R. Childers, and Mary Lou Soffa, in AADEBUG '05, Sep. 19-21, 2005, Monterrey, Calif.

In one or more embodiments of the invention, the mapping and breakpoint module may include one or more data structures in order to maintain the mappings. Suitable data structures include, but are not limited to, linked lists, maps of standard template library (STL), arrays, and the like, and combinations of such data structures. The mappings may also optionally be implemented in hardware, such as, for example, a cache.

The mapping and breakpoint module is in bidirectional communication with the interceptor module. The mapping and breakpoint module may provide mappings, such as, for example, UT mappings and/or TU mappings, to the interceptor module.

Accordingly, in one or more embodiments of the invention, the interceptor module may intercept an OS services call or communication from the debugger. The interceptor module may then communicate with the mapping and breakpoint module in order to determine mapped or otherwise alternate locations or other arguments.

Then, in accordance with one or more embodiments of the invention, the interceptor module may use code or other logic thereof to generate another OS services call or communication that transparently takes dynamic translation and/or dynamic instrumentation into account. In one or more embodiments of the invention, the OS services call or communication generated by the interceptor module may be based, at least in part, on the intercepted OS services call or communication, and also based, at least in part, on the alternate locations or other arguments received from the mapping and breakpoint module. For example, in one or more embodiments of the invention, the interceptor module may replace or otherwise modify an argument of the intercepted OS services call with the alternate argument received from the mapping and breakpoint module. As discussed above, the alternate argument may be determined by the mapping and breakpoint module based on information received from the dynamic translation and/or dynamic instrumentation system and may accurately take affects of dynamic translation and/or dynamic instrumentation into account. As one particular example, the interceptor module may swap an address of an instruction of the un-translated source code specified in the intercepted OS services call with a corresponding address of the instruction of the translated target code. The interceptor module is in communication with the OS module, such as, for example, the ptrace module in a GNU/Linux implementation, and may provide an OS service call with the modified arguments to the OS module.

The interception module may also include a signal handler to override the wait system call and intercept signals that are issued from the dynamic translation and/or instrumentation system during the process of debugging. As shown in the illustrated embodiment a signal notification may be provided from the dynamic translation and/or instrumentation system process to the interceptor module. Traditionally the signals would go directly to the debugger. After intercepting the signals, the mapping module may be consulted in order to determine mapping information to map an address or location of the translated code specified in the signal to a corresponding address or location of the untranslated code that may be provided to the debugger.

In one or more embodiments of the invention, the interceptor module and the mapping and breakpoint module may include code. The code may optionally be written in C or C++. Alternatively, other languages such as, for example, Perl, Java, Delphi, APL, Lisp, Tcl, Prolog, Python, or the like, may optionally be used.

In one or more embodiments of the invention, the interceptor module and/or the mapping and breakpoint module may be implemented as a dynamically linked or shared library. The dynamically linked or shared library may be injected into the debugger before the debugger is started. For example, in the GNU/Linux operating system, a shared library including the interceptor module and the mapping and breakpoint module may be preloaded into the debugger program by using the environment variable LD_PRELOAD. The ptrace system call on GNU/Linux may go through system libraries that are present as shared libraries on the GNU/Linux system. The system libraries may be loaded into any program that needs to use them at run-time. For example, LD_PRELOAD may be used to load a modified version of ptrace whenever a debugger tries to use ptrace. The modified version of ptrace may include a wrapper to the standard ptrace. When the modified version of ptrace is invoked, it may call and use the standard ptrace with modified arguments. Even though many application programs use such system libraries, these system libraries are not considered herein to be part of the application program even though when they are running they may be the same process image. The modified ptrace logic may reside at the operating system level. The OS need not be modified or even recompiled or restarted. The debugger need not be substantially modified. Not having to modify the source code or binary of a debugger may offer certain potential advantages. Modifying debuggers may tend to be challenging. After modification of the debuggers, costly testing may be needed in order to verify the modification. Additionally, for some proprietary debuggers or legacy debuggers the source code may not be readily available. Additionally, a given user may prefer a particular one of the numerous available debuggers. A potential advantage is that any one of the numerous debuggers may be used without having to modify all of the numerous debuggers to support dynamic translation and/or dynamic instrumentation.

Alternate embodiments are also contemplated. For example, in one or more embodiments of the invention, the interceptor and mapping unit as disclosed herein, or a portion thereof, such as, for example, the interceptor module and/or the mapping and breakpoint module, may optionally be integrated with the operating system. As another example, in one or more embodiments of the invention, the interceptor and mapping unit as disclosed herein, or a portion thereof, such as, for example, the interceptor module and/or the mapping and breakpoint module, may optionally be integrated with the dynamic translation and/or instrumentation system.

III. Detailed Description of Exemplary OS Services Processing

A. Signal Handling

Signals or other notifications may be issued when execution of a program is stopped. In one or more embodiments of the invention, the interceptor and mapping unit may implement a method to process such signals or notifications.

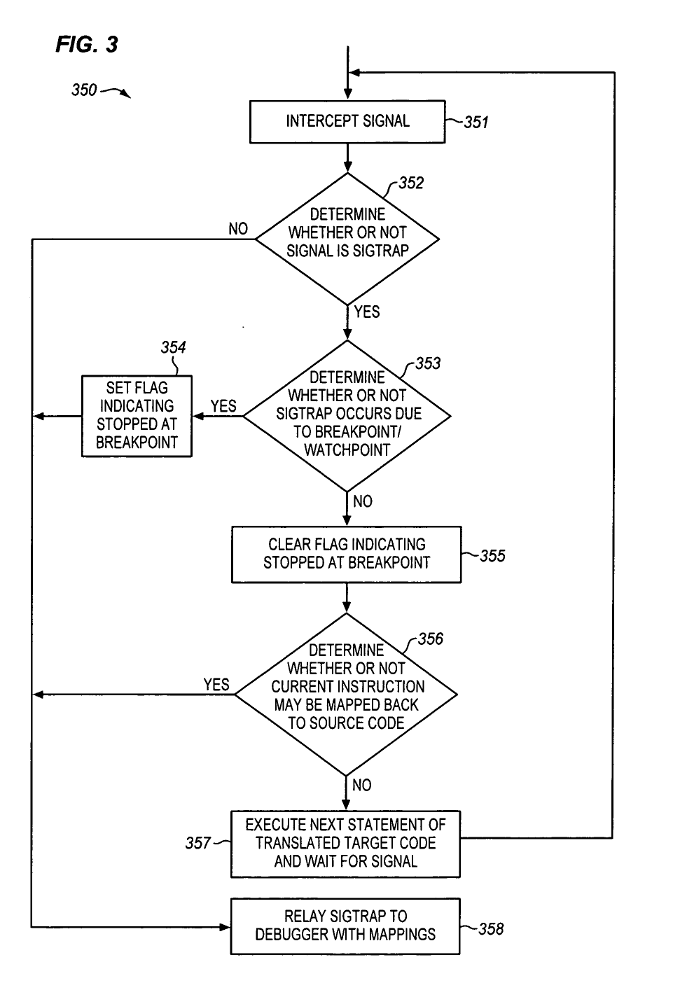

FIG. 3 is a flow diagram of a method of signal handling 350, according to one or more embodiments of the invention. In one or more embodiments of the invention, the method may be performed by an interceptor and mapping unit.

Initially, the interceptor module may intercept a signal, at block 351. Then, as shown in the illustrated embodiment at block 352, in the particular case of a UNIX system, the interceptor module may determine whether or not the signal is the well-known signal SIGTRAP. Alternate methods are contemplated for non-Unix systems in which an analogous determination is made using a signal that roughly corresponds to SIGTRAP.

If the interceptor module determines that the signal is not SIGTRAP (i.e., “no” is the determination), then processing may proceed to block 358. The operation performed at block 358 will be discussed further below. Alternatively, if the interceptor module determines that the signal is SIGTRAP (i.e., “yes” is the determination), then processing may proceed to block 353.

A SIGTRAP signal may be received under different conditions, such as, for example, when a breakpoint and/or watchpoint has occurred and when a single-step operation has been performed. At block 353, the interceptor module may make another determination. In particular, the interceptor module may determine whether or not the SIGTRAP has occurred due to a breakpoint and/or watchpoint. In one or more embodiments, this determination may be made by inspecting the last instruction executed (program counter−1) and determining whether or not this instruction has a breakpoint trap instruction, although the scope of the invention is not limited in this respect. If the breakpoint/watchpoint was a hardware breakpoint/watchpoint, for example set in a debug register, then the register or other hardware may be inspected to determine whether or not execution stopped due to a breakpoint.

If the interceptor module determines that the SIGTRAP has occurred due to a breakpoint and/or watchpoint (i.e., “yes” is the determination), then processing may proceed to block 354. At block 354 a flag may be set indicating that the program has been stopped due to a breakpoint/watchpoint. From block 354, processing may continue to block 358.

Alternatively, if the interceptor module determines that the SIGTRAP has not occurred due to a breakpoint and/or watchpoint (i.e., “no” is the determination), then processing may proceed to block 355. At block 355, a flag may be cleared to indicate that a program has not been stopped due to a breakpoint/watchpoint. Processing may proceed from block 355 to block 356.

At block 356, the interceptor module may determine whether to notify the debugger right at this point or instead roll execution ahead to another point before notifying the debugger. By way of example, execution may be rolled ahead when the current program counter corresponds to instrumentation code that is to be hidden from or transparent to the user and debugger. In particular, the interceptor module may determine whether or not the current instruction of the translated target code may be mapped back to the un-translated source code. The interceptor module may communicate with the mapping and breakpoint module as described elsewhere herein in order to make this determination. In one aspect, the debugger may be notified only when the present location may be related back to the original untranslated source code by using the debug mappings.

If the interceptor module determines that the current instruction of the translated target code may be mapped back to the un-translated source code (i.e., “yes” is the determination), then processing may proceed to block 358. Alternatively, if the interceptor module determines that the current instruction of the translated target code may not be mapped back to the un-translated source code (i.e., “no” is the determination), then processing may proceed to block 357.

At block 357, the next statement of the translated target code may be executed and then the interceptor module may await a signal. In other words, a single-step operation may be performed. Then, processing may revisit or return to block 351. The method may cycle through blocks 351 and 357 one or more times until, at some point, the interceptor module may determine that the current instruction of the translated target code may be mapped back to the un-translated source code (i.e., “yes” may be the determination). In which case, processing may proceed to block 358.

At block 358, the SIGTRAP signal, or analogous signal in a non-UNIX implementation, may be relayed to the debugger with mappings.

B. Reading from a Register

A debugger may read register values of an executing program, such as, for example, in order to inspect the current stopped location and/or values of variables in the program. In one or more embodiments of the invention, the interceptor and mapping unit may implement a method to provide the debugger the read information in terms of addresses in the untranslated source code even when dynamic translation and/or instrumentation are being performed.

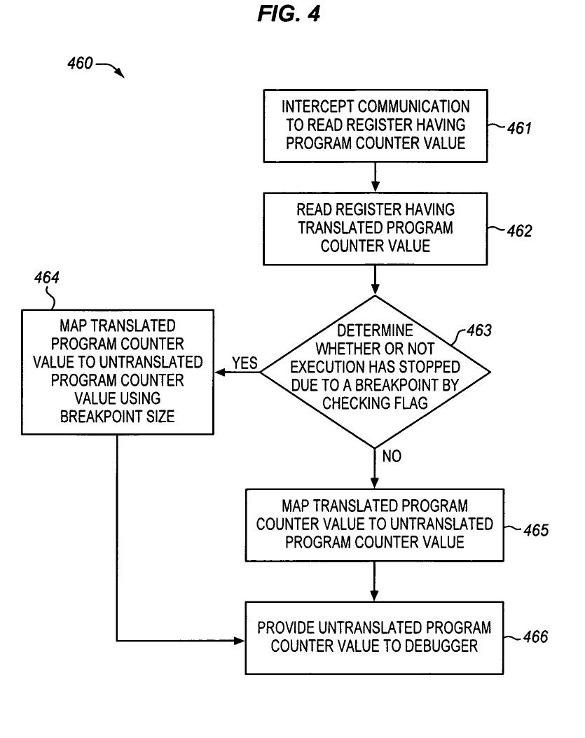

FIG. 4 is a flow diagram of a method of reading register values 460, according to one or more embodiments of the invention. In one or more embodiments of the invention, the method may be performed by a interceptor and mapping unit.

Initially, the interceptor module may intercept a communication to read a program counter value of a register, at block 461. For example, in one or more embodiments of the invention, the interceptor module may intercept a ptrace system call specifying to read the program counter value of the register.

Then, the interceptor module may read the register having the translated program counter value, at block 462. In one or more embodiments of the invention, the interceptor module may communicate with the mapping and breakpoint module to determine an alternate argument by a UT mapping, and then issue a new system call using the alternate argument in order to read the translated program counter value.

Next, the interceptor module may determine whether or not execution has stopped due to a breakpoint, at block 463. In one or more embodiments of the invention a flag may be checked to make this determination, although the scope of the invention is not limited in this respect. If the interceptor module determines that execution has in fact stopped due to a breakpoint (i.e., “yes” is the determination), then processing may proceed to block 464.

At block 464, the interceptor module may map the translated program counter value that was read to an untranslated program counter value by using a breakpoint size. When execution is stopped due to a breakpoint, the value of the translated program counter in the register is the current stopped location, which is the starting address of the breakpoint location offset by the size of the breakpoint. It may not be possible to map this translated program counter value corresponding to the current stopped location back to an untranslated program counter value, although it may be possible to translate the breakpoint location back. In one or more embodiments of the invention, a location may be determined by subtracting the breakpoint size from the translated program counter value, and then this location may be mapped back to the untranslated code by consulting the mapping and breakpoint module for a TU mapping. Then the untranslated location may be offset by the breakpoint size. The method may then advance to block 466.

With reference again to determination block 463, if the interceptor module instead determines that execution has not stopped due to a breakpoint (i.e., “no” is the determination), then processing may proceed to block 465. At block 465, the interceptor module may map the translated program counter value that was read to an untranslated program counter value directly. The method may then advance to block 466. At block 466, the untranslated program counter value may be provided to the debugger.

C. Writing to a Register

In some cases, a debugger may attempt to write or modify values of a register. There are various reasons for doing this. One such reason is to modify a value of a program counter when a user wants to start execution from a different location. Another such reason is to adjust a value of a program counter when continuing from a breakpoint, adjusting by the size of the breakpoint instruction. In one or more embodiments of the invention, the interceptor and mapping unit may implement a method to intercept and process commands from the debugger that modify the value of the program counter so that control does not exit from the code cache.

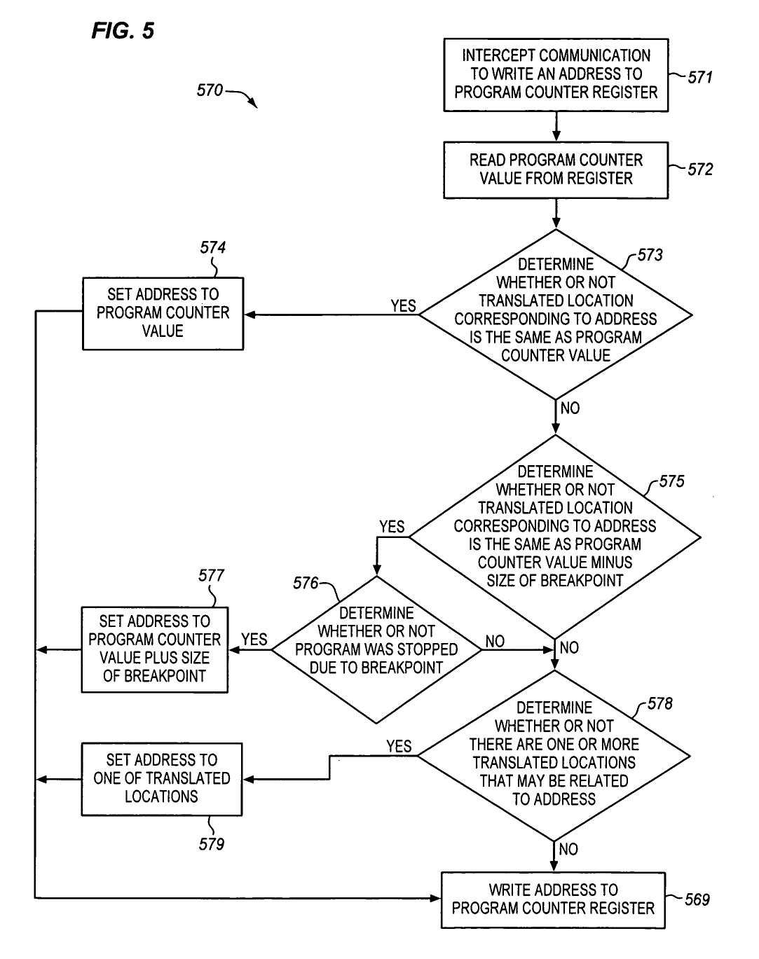

FIG. 5 is a flow diagram of a method of writing values to a register 570, according to one or more embodiments of the invention. In one or more embodiments of the invention, the method may be performed by an interceptor and mapping unit.

Initially, the interceptor module may intercept a communication to write an address to a program counter register, at block 571. For example, in one or more embodiments of the invention, the interceptor module may intercept a ptrace system call specifying to such a write operation. Then, the interceptor module may read the program counter value from the program counter register, at block 572.

Next, the interceptor module may determine whether or not a translated location corresponding to the address specified by the intercepted communication is the same as the read program counter value, at block 573.

If at block 573 the interceptor module determines that a translated location corresponding to the address specified in the intercepted communication is the same as the read program counter value (i.e., “yes” is the determination), then processing may proceed to block 574. At block 574, the address may be set to the program counter value. Processing may the proceed to block 569.

Alternatively, if at block 573 the interceptor module determines that a translated location corresponding to the address is not the same as the program counter value (i.e., “no” is the determination), then processing may proceed to block 575. At block 575, the interceptor module may determine whether or not a translated location corresponding to the address specified in the intercepted communication is the same as the program counter value minus a size of a breakpoint.

If at block 575 the interceptor module determines that the translated location corresponding to the address specified in the intercepted communication is not the same as the program counter value minus a size of a breakpoint (i.e., “no” is the determination), then processing may proceed to block 578. Alternatively, if at block 575 the interceptor module determines that the translated location corresponding to the address specified in the intercepted communication is in fact the same as the program counter value minus a size of a breakpoint (i.e., “yes” is the determination), then processing may proceed to block 576.

At block 576, the interceptor module may determine whether or not the program was stopped due to a breakpoint. In one or more embodiments of the invention, the interceptor module may check a value of a flag in order to make this determination, although the scope of the invention is not limited in this respect.

If at block 576 the interceptor module determines that the program was in fact stopped due to a breakpoint (i.e., “yes” is the determination), then processing may proceed to block 577. At block 577, an address may be set to the program counter value plus the size of the breakpoint. In other words, the program counter may be adjusted by the size of the breakpoint after hitting the breakpoint. This may be used after continuing from a breakpoint, for example. Processing may then continue to block 569.

Alternatively, if at block 576 the interceptor module determines that the program was not stopped due to a breakpoint (i.e., “no” is the determination), then processing may proceed to block 578.

At block 578, which may be arrived at either from block 576 or from block 575, yet another determination may be made. In particular, at block 578, the interceptor module may determine whether or not there are one or more translated locations that may be related to the address.

If at block 578 the interceptor module determines that there are in fact one or more translated locations that may be related to the address (i.e., “yes” is the determination), then processing may proceed to block 579. At block 579, an address may be set to one of the translated locations. This operation may reflect an effort to keep execution within the code cache by trying to map the value being written by the intercepted communication to a potentially arbitrarily chosen one of the available code cache locations. Processing may then proceed to block 569.

Alternatively, if at block 578 the interceptor module determines that there are not one or more translated locations that may be related to the address (i.e., “no” is the determination), then processing may proceed directly to block 569.

At block 569, the interceptor module may write the original address specified by the intercepted communication to the program counter register. This may occur, for instance, if the user attempts to make a random jump to a program location. In such cases, the interceptor module may potentially be unable to map the value being written to a code cache location. In such cases, control may potentially exit from the code cache. In one or more embodiments of the invention, an alarm or warning may optionally be provided to the user in such cases.

D. Writing to Memory

In some cases, a debugger may attempt to write to an application program's address space, such as, for example, main memory. By way of example, a user may perform such writes to add or remove breakpoints. In one or more embodiments of the invention, the interceptor and mapping unit may implement a method to intercept and process write commands or communications from the debugger that attempt to write to an application program's address space.

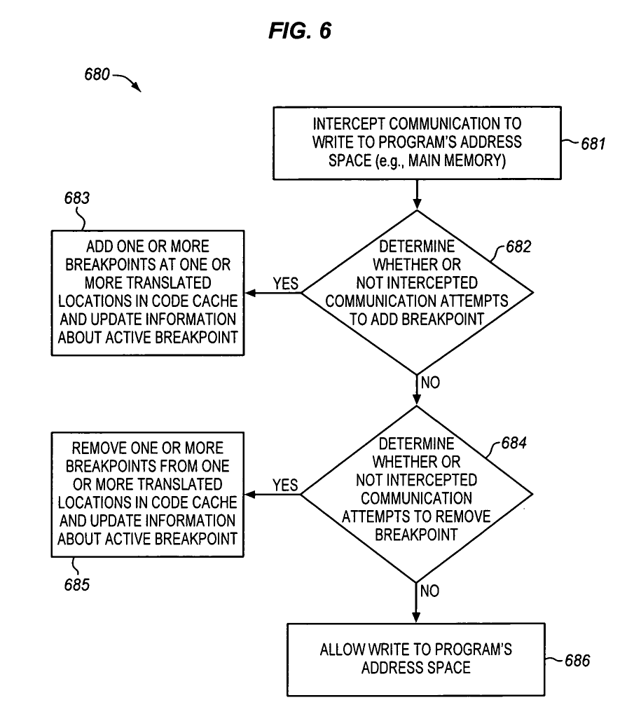

FIG. 6 is a flow diagram of a method of writing values to a programs address space (for example main memory) 680, according to one or more embodiments of the invention. In one or more embodiments of the invention, the method may be performed by an interceptor and mapping unit.

Initially, the interceptor module may intercept a ptrace system call or other communication to write to a program's address space, at block 681.

Then, the interceptor module may determine whether or not the intercepted communication attempts to add a breakpoint, at block 682. If the interceptor module determines that the intercepted communication does attempt to add a breakpoint (i.e., “yes” is the determination), then processing may proceed to block 683.

At block 683, the interceptor module may add one or more breakpoints at one or more translated locations in the code cache. Adding a breakpoint may include writing a breakpoint trap instruction into the application program. The interceptor module may communicate with the mapping and breakpoint module to look up a UT debug mappings for the breakpoint location specified in the intercepted communication. The UT mapping may indicate one or more corresponding alternate translated locations in the code cache where breakpoints should be inserted. The interceptor module may then issue one or more commands to insert one or more breakpoints at the one or more determined translated locations in the code cache. The interceptor module may also update the breakpoint information in the breakpoint repository of the debug engine by saving the original instructions at each of these locations determined by mapping.

With reference again to determination block 682, if the interceptor module instead determines that the intercepted communication does not attempt to add a breakpoint (i.e., “no” is the determination), then processing may proceed to block 684. At block 684, the interceptor module may determine whether or not the intercepted communication attempts to remove a breakpoint. Breakpoints may be removed by adding back the original instruction that existed before the breakpoint was added. In one or more embodiments of the invention, the interceptor module may determine that a breakpoint is being removed if the location and data being written to are represented in the breakpoint repository that is maintained by the mapping and breakpoint module.

If the interceptor module determines that the intercepted communication does attempt to remove a breakpoint (i.e., “yes” is the determination), then processing may proceed to block 685. At block 685, the interceptor module may remove all of the one or more breakpoints from the one or more translated locations in the code cache. As discussed above, breakpoints may be removed by adding back the original instruction that existed before the breakpoint was added.

Alternatively, if at block 684 the interceptor module instead determines that the intercepted communication does not attempt to remove a breakpoint, then processing may proceed to block 686. At block 686, the write to the program's address space may be allowed to proceed. It is recognized that in some cases users may elect to instruct modification of instructions and/or data in the program's address space. Such modifications may not be reflected in the translated target code that has already been translated and stored in the code cache. The interceptor module of one or more embodiments of the invention may not attempt to alleviate such discrepancies.

Other communications, such as, for example, continue or single-step, do not require substantial novel processing by the interceptor and mapping unit. Other debug commands may be built using the above-described commands as building blocks or models.

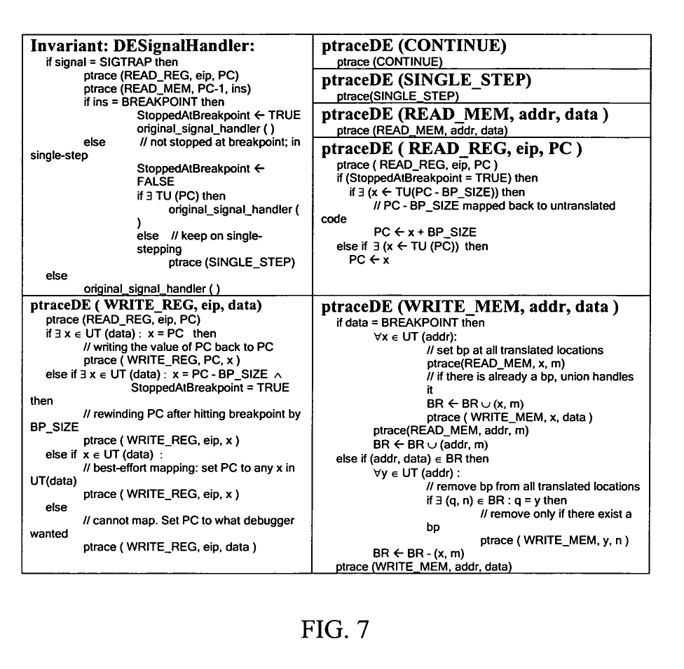

FIG. 7 lists formal notation representing methods similar to those described above in FIGS. 3-6, and which are also suitable for one or more embodiments of the invention. As shown, in one or more embodiments of the invention, ptrace calls may be wrapped within calls that have been redefined and renamed and that are configured to be intercepted by the interceptor module. As one example, ptrace calls may be wrapped within ptraceDE calls to the interceptor module. Upon receiving the wrapped calls, the interceptor module may change one or more arguments of the ptrace call by using the mapping and breakpoint module and then issue a standard ptrace call to the operating system with the changed arguments to obtain services from the operating system.

IV. Exemplary Computer Architecture

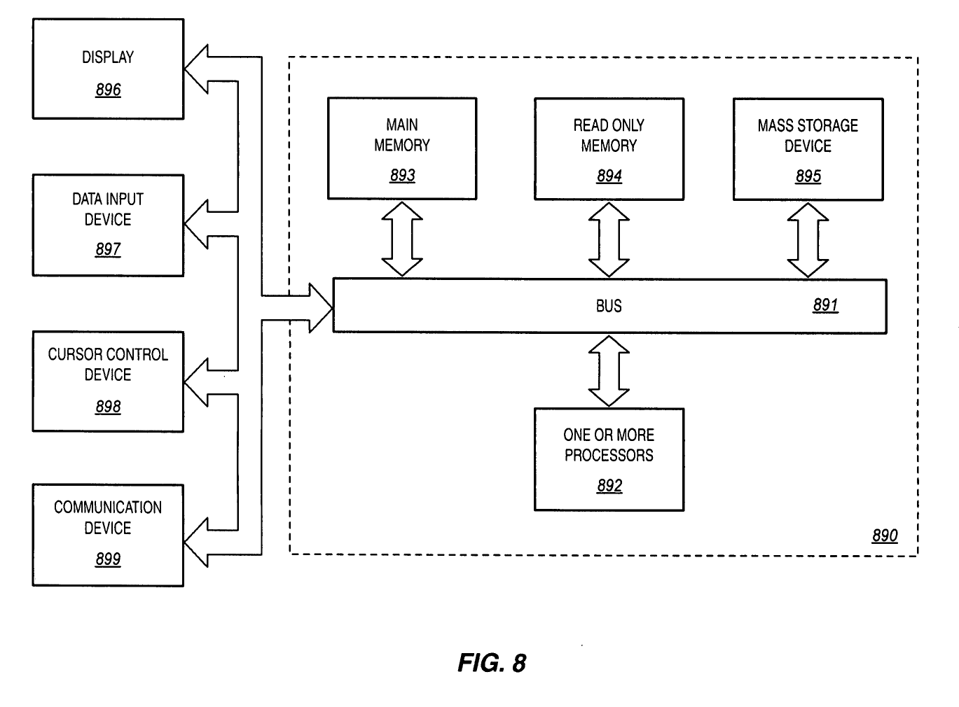

FIG. 8 shows a block diagram of a computer system 890 upon which one or more embodiments of the invention may be implemented. As used herein, a “system” or “computer system” may include an apparatus having hardware and/or software to process data. The computer system may include, but is not limited to, a portable, laptop, desktop, server, or mainframe computer, to name just a few examples. The computer system represents one possible computer system for implementing one or more embodiments of the invention, however other computer systems and variations of the computer system are also possible.

The computer system includes a bus 891 to communicate information, and one or more processors 892 coupled with the bus to process information. In one or more embodiments of the invention, the processor may include a microprocessor available from Intel Corporation, of Santa Clara, Calif. The computer system further includes a main memory 893, such as, for example, a random access memory (RAM) or other dynamic storage device, coupled with the bus to store information including instructions to be executed by the processor. Different types of RAM memory that are included in some, but not all computer systems, include, but are not limited to, static-RAM (SRAM) and dynamic-RAM (DRAM).

The computer system also includes a read only memory (ROM) 894 coupled with the bus to store static information and instructions for the processor, such as, for example, the basic input-output system (BIOS). Different types of memory that are included in some, but not all, computer systems include Flash memory, programmable ROM (PROM), erasable-and-programmable ROM (EPROM), and electrically-erasable-and-programmable ROM (EEPROM). A mass storage device 895 such as, for example, a magnetic disk, zip, or optical disc, and its corresponding drive, may also optionally be coupled with the computer system to store information and instructions.

The computer system may also optionally be coupled via the bus with a display device 896, such as, for example, a cathode ray tube (CRT) or liquid crystal display (LCD), to display information to an end user. A data input device 897, such as, for example, a keyboard or other alphanumeric input device including alphanumeric and other keys, may optionally be coupled with the bus to communicate information and command selections to the processor. Another type of user input device that may optionally be included is a cursor control device 898, such as, for example, a mouse, trackball, or cursor direction keys, to communicate direction information and command selections to the processor, and to control cursor movement on the display device.

A communication device 899 may also optionally be coupled with the bus. Communication devices are included in some, but not all, computer systems. Depending upon the particular implementation, the communication device may include a modem, a network interface card, or other well-known interface devices, such as, for example, those used for coupling with Ethernet, token ring, or other types of physical attachment for purposes of providing a communication link to support a local or wide area network, for example.

Embodiments of the invention are not limited to any particular computer system. Rather, one or more embodiments may be used on any stand alone, distributed, networked, or other type of computer system. For example, one or more embodiments may be used on one or more computers compatible with NT, Linux, Windows, Macintosh, any variation of Unix, or others.

V. Other Matters

In the description above, for the purposes of explanation, numerous specific details have been set forth in order to provide a thorough understanding of the embodiments of the invention. It will be apparent however, to one skilled in the art, that one or more other embodiments may be practiced without some of these specific details. The particular embodiments described are not provided to limit the invention but to illustrate it. The scope of the invention is not to be determined by the specific examples provided above but only by the claims below. In other instances, well-known circuits, structures, devices, and operations have been shown in block diagram form or without detail in order to avoid obscuring the understanding of the description.

It will also be appreciated, by one skilled in the art, that modifications may be made to the embodiments disclosed herein, such as, for example, to the functions, and manner of operation of the components of the embodiments. All equivalent relationships to those illustrated in the drawings and described in the specification are encompassed within embodiments of the invention.

Various operations and methods have been described. Some of the methods have been described in a basic form, but operations may optionally be added to and/or removed from the methods. The operations of the methods may also often optionally be performed in different order. Many modifications and adaptations may be made to the methods and are contemplated.

Certain operations may be performed by hardware components, or may be embodied in machine-executable instructions, that may be used to cause, or at least result in, a circuit programmed with the instructions performing the operations. The circuit may include a general-purpose or special-purpose processor, or logic circuit, to name just a few examples. The operations may also optionally be performed by a combination of hardware and software.

One or more embodiments of the invention may be provided as a program product or other article of manufacture that may include a machine-accessible and/or readable medium having stored thereon one or more instructions and/or data structures. The medium may provide instructions, which, if executed by a machine, may result in and/or cause the machine to perform one or more of the operations or methods disclosed herein. Suitable machines include, but are not limited to, desktops, laptops, servers, mainframes, and other computer systems known in the art, as well as other types of devices including one or more processors.

The medium may include, a mechanism that provides, for example stores and/or transmits, information in a form that is accessible by the machine. For example, the medium may optionally include recordable and/or non-recordable mediums, such as, for example, floppy diskette, optical storage medium, optical disk, CD-ROM, magnetic disk, magneto-optical disk, read only memory (ROM), programmable ROM (PROM), erasable-and-programmable ROM (EPROM), electrically-erasable-and-programmable ROM (EEPROM), random access memory (RAM), static-RAM (SRAM), dynamic-RAM (DRAM), Flash memory, and combinations thereof.

For clarity, in the claims, any element that does not explicitly state “means for” performing a specified function, or “step for” performing a specified function, is not to be interpreted as a “means” or “step” clause as specified in 35 U.S.C. Section 112, Paragraph 6. In particular, any potential use of “step of” in the claims herein is not intended to invoke the provisions of 35 U.S.C. Section 112, Paragraph 6.

It should also be appreciated that reference throughout this specification to “one embodiment”, “an embodiment”, or “one or more embodiments”, for example, means that a particular feature may be included in the practice of the invention. Similarly, it should be appreciated that in the description various features are sometimes grouped together in a single embodiment, Figure., or description thereof for the purpose of streamlining the disclosure and aiding in the understanding of various inventive aspects. This method of disclosure, however, is not to be interpreted as reflecting an intention that the invention requires more features than are expressly recited in each claim. Rather, as the following claims reflect, inventive aspects may lie in less than all features of a single disclosed embodiment. Thus, the claims following the Detailed Description are hereby expressly incorporated into this Detailed Description, with each claim standing on its own as a separate embodiment of the invention.

Accordingly, while the invention has been thoroughly described in terms of several embodiments, those skilled in the art will recognize that the invention is not limited to the particular embodiments described, but may be practiced with modification and alteration within the spirit and scope of the appended claims. The description is thus to be regarded as illustrative instead of limiting.

What is claimed is:

1. A method comprising:
intercepting a communication from a debugger, the communication specifying an address of an un-translated code;
receiving translation information from a dynamic translation system;
mapping the address of the un-translated code to an address of a translated code by using the translation information received from the dynamic translation system; and
issuing an operating system service call corresponding to the intercepted communication to an operating system module, the operating system service call specifying the address of the translated code.

2. The method of claim 1, wherein said issuing the operating system service call comprises issuing a ptrace call.

3. The method of claim 1, further comprising setting an environmental variable to specify the interception of the communication from the debugger.

4. The method of claim 1, further comprising:
intercepting a signal indicating execution has stopped; and
transparently executing one or more other instructions to hide code from the debugger without communicating the intercepted signal to the debugger.

5. An article of manufacture comprising:
a machine-accessible medium that provides instructions that if executed result in a machine performing operations including,
receiving a communication from a debugger, the communication specifying an argument pertaining to an un-translated code;
receiving information from a dynamic translation system;
relating the argument pertaining to the un-translated code to an argument pertaining to a translated code by using the information received from the dynamic translation system;
providing a call corresponding to the received communication to an operating system, the call specifying the argument pertaining to the translated code.

6. The article of manufacture of claim 5, wherein the machine-accessible medium further provides instructions that if executed result in the machine performing operations including,
receiving the communication from the debugger by intercepting the communication.

7. The article of manufacture of claim 5, wherein the machine-accessible medium further provides instructions that if executed result in the machine performing operations including,
providing the call by using a ptrace call.

8. The article of manufacture of claim 5, wherein the machine-accessible medium further provides instructions that if executed result in the machine performing operations including,
performing said relating by accessing a data structure that relates the argument pertaining to the un-translated code to the argument pertaining to the translated code.

9. The article of manufacture of claim 5, wherein the machine-accessible medium further provides instructions that if executed result in the machine performing operations including,
further comprising setting an environmental variable to specify the reception of the communication from the debugger.

10. The article of manufacture of claim 5, wherein the machine-accessible medium further provides instructions that if executed result in the machine performing operations including:
intercepting a signal indicating execution has stopped; and
transparently executing one or more other instructions to hide code from the debugger without communicating the intercepted signal to the debugger.

11. An apparatus comprising:
an interceptor module including at least one instruction stored on a machine-accessible medium, the interceptor module to intercept a communication from a debugger, the communication specifying an address of an un-translated code;
a mapping module in communication with the interceptor module and capable of communicating with a dynamic translation system to receive translation information, the mapping module to map the address of the un-translated code to an address of a translated code by using the translation information, and provide the address of the translated code to the interceptor module,
wherein the interceptor module is to issue an operating system service call corresponding to the intercepted communication, the operating system service call specifying the address of the translated code.

12. The apparatus of claim 11, wherein at least one of the interceptor module and the mapping module is implemented as a dynamically shared library.

13. The apparatus of claim 11, wherein at least one of the interceptor module and the mapping module is integrated with an operating system.

14. The apparatus of claim 11, wherein the interceptor module further comprises a signal handler to intercept signals indicating execution has stopped from a dynamic translation system.

15. A system comprising:
a bus;
one or more processors coupled with the bus;
a dynamic random access memory (DRAM) coupled with the bus; and
instructions stored on the DRAM that if executed result in the one or more processors performing operations including,
receiving a communication from a debugger, the communication specifying an argument pertaining to an un-translated code;
receiving information from a dynamic translation system;
relating the argument pertaining to the un-translated code to an argument pertaining to a translated code by using the information received from the dynamic translation system;
providing a call corresponding to the received communication to an operating system, the call specifying the argument pertaining to the translated code.

16. The system of claim 15, wherein the instructions further include instructions that if executed result in the one or more processors performing operations including,
receiving the communication from the debugger by intercepting the communication.

17. The system of claim 15, wherein the instructions further include instructions that if executed result in the one or more processors performing operations including,
providing the call by using a ptrace call.

18. The system of claim 15, wherein the instructions further include instructions that if executed result in the one or more processors performing operations including,
intercepting a signal indicating execution has stopped; and
transparently executing one or more other instructions to hide code from the debugger without communicating the intercepted signal to the debugger.
